(19) United States
(12) Patent Application Publication
(10) Pub. No.: US 2006/0085435 A1
(43) Pub. Date: Apr. 20, 2006

(54) Method and data processing system for displaying hierarchical tree data

(75) Inventor: Brian G. Farn, Toronto (CA)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/965,142

(22) Filed: Oct. 14, 2004

(51) Int. Cl. G06F 7/00

(52) U.S. Cl. 707/100

(57) ABSTRACT

A method, apparatus, and computer instructions for controlling a display of hierarchical data. A selected node in a hierarchical tree is displayed on a display in the data processing system to identify whether the selected node, wherein plurality of modes of expansion are present for the selected node. The selected node is expanded in the mode of expansion.

### BACKGROUND OF THE INVENTION

1. Technical Field

The present invention relates generally to an improved data processing system and in particular to a method and apparatus for processing data. Still more particularly, the present invention provides a method, apparatus, and computer instructions for displaying data in a hierarchical format.

2. Description of Related Art

In today's computing environment, large amounts of data are being generated and stored. Many different types of systems are present for searching and viewing data. One of these systems involves a graphical user interface (GUI) that presents folders and files in a hierarchical format. The arrangement of folders forms hierarchical data that may be presented to a user.

For example, a user interface tree control is used by programmers to display hierarchical data in hierarchical tree form. A hierarchical tree consists of nodes, where each node in the tree may have child nodes. Each node with child nodes may either be in an expanded state where its child nodes are shown, or in a contracted state where its child nodes are not shown. When a node is expanded, an indicator symbol such as a plus sign, resides next to the node. When a node is contracted, an indicator symbol such as a minus sign, resides next to the node. Each node without child nodes are called leaf nodes. Leaf nodes do not have an expansion or contraction indicator beside them. Current user interface trees only expand child nodes in a vertical orientation beneath the parent node. This restriction has a number of limitations. For example, whenever multiple nodes are expanded, a vertically oriented tree may have to be scrolled excessively in order to navigate from one part of the tree to another. A tree occupies space mostly in a vertical direction. The horizontal space is not effectively used. Additionally, a user does not have any control over how nodes are to be arranged based upon information type or preference.

Currently, no known solutions are present to solve these problems. Thus, it would be advantageous to have an improved method, apparatus, and computer instructions for presenting hierarchical data in a tree format.

### SUMMARY OF THE INVENTION

The present invention provides a method, apparatus, and computer instructions for controlling a display of hierarchical data. A mode of expansion is identified for a selected node, in response to a selection of the selected node in a hierarchical tree being displayed on a display in the data processing system. A plurality of modes of expansion are present for the selected node. The selected node is expanded in the mode of expansion.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram illustrating a vertical mode of expansion, in accordance with a preferred embodiment of the present invention;

FIG. 4 is a diagram illustrating a horizontal expansion mode, in accordance with a preferred embodiment of the present invention;

FIGS. 5A and 5B are diagrams illustrating a vertical exclusive mode of expansion, in accordance with a preferred embodiment of the present invention;

FIGS. 6A and 6B are diagrams illustrating a horizontal exclusive mode of expansion, in accordance with a preferred embodiment of the present invention;

FIG. 7 is a diagram illustrating combined expansion modes, in accordance with a preferred embodiment of the present invention;

FIG. 8 is a control for selecting an expansion mode or direction, in accordance with a preferred embodiment of the present invention; and

FIG. 9 is a flowchart illustrating expanding modes, in accordance with a preferred embodiment of the present invention.

### DETAILED DESCRIPTION OF THE PREFERRED EMBODIMENT

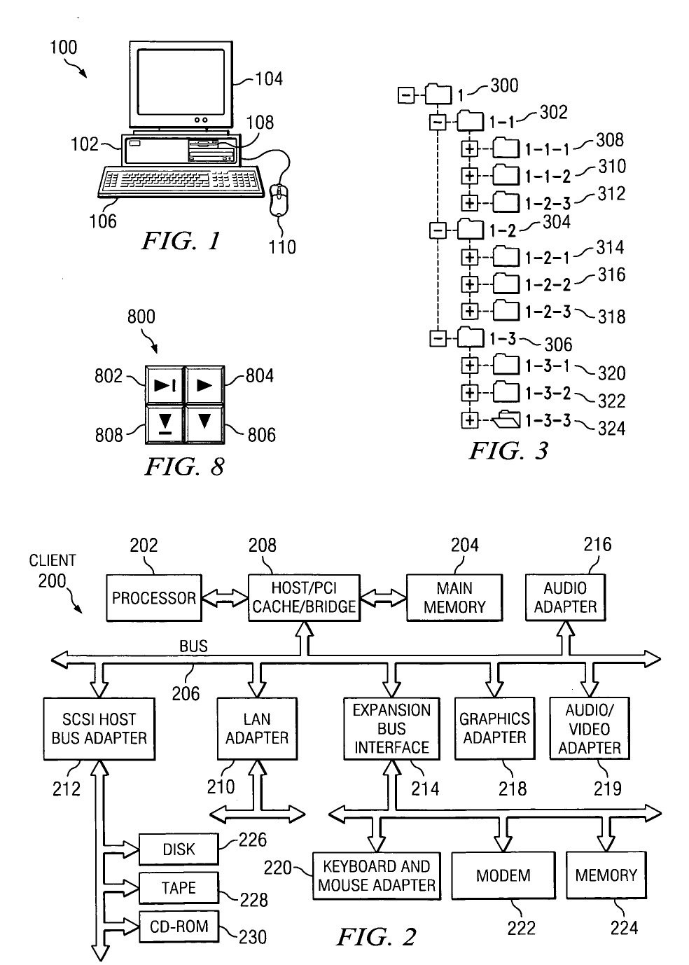

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors.

In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent non-volatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention provides a method, apparatus, and computer instructions for displaying nodes in a hierarchical tree presented to a user on a display. The mechanism of the present invention includes a hierarchical tree control that improves upon existing hierarchical tree controls by providing a user interacting with the tree control, the ability to expand each expandable node in more than one way or direction. For example, a user may expand an expandable node in a number of different directions. For example, an expandable node may be expanded in one of the following ways: vertical, horizontal, vertical exclusive, and horizontal exclusive. With vertical expansion, the nodes are expanded with child nodes arranged below the current node in a vertical direction. This type of expansion is presently used. Horizontal expansion occurs when a node is expanded with child nodes arranged in a horizontal direction. A vertical exclusive expansion mode involves the expansion of a node with child nodes being arranged in a vertical direction. In this type of expansion, all of the sibling nodes are contracted. A sibling node is a node that has the same parent node as the specified or selected node. Horizontal exclusive is a mode of expansion in which a node is expanded with child nodes being arranged in a horizontal direction. In this type of expansion, all sibling nodes are contracted.

The mechanism of the present invention may identify or use any one of these expansion modes at any one time. The selection of a particular direction in which nodes are expanded may be set by default, by a software application, or through a user input.

The diagrams in FIGS. 3-8 illustrate different modes of expansion used to present nodes that have hierarchical relations. Specifically, example hierarchical trees are presented to illustrate the different types of expansion provided in these illustrative examples. The different hierarchical trees are examples of trees that may be displayed and manipulated by users through a user interface tree control. An example of such an interface is Windows Explorer, which is found in Windows operating systems from Microsoft Corporation.

Turning now to FIG. 3, a diagram illustrating a vertical mode of expansion is depicted in accordance with a preferred embodiment of the present invention. In this example, node 300 is a node selected for expansion. Nodes 302, 304, and 306 are child nodes to node 300. These child nodes also have been selected for expansion. Node 302 has been expanded to show nodes 308, 310, and 312. As can be seen, the expansion in this case, occurs in a vertical direction.

Node 304 has been expanded vertically to show nodes 314, 316, and 318. These nodes are child nodes to node 304. Additionally, nodes 320, 322, and 324 are child nodes to node 306. In summary, nodes 300, 302, 304, and 306 are expanded in a vertical mode or direction.

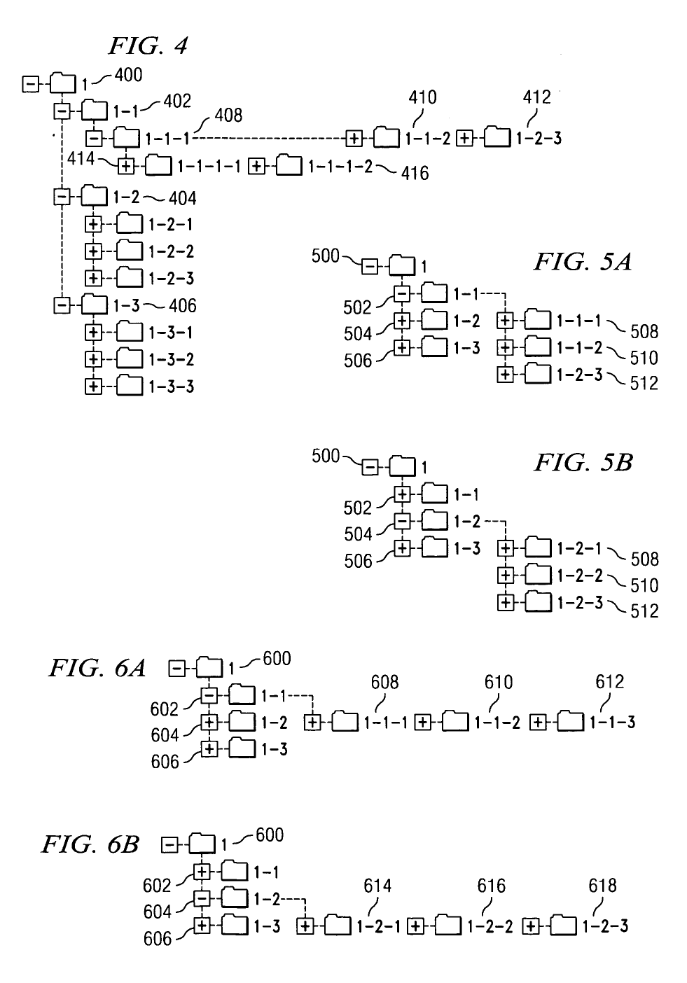

With reference next to FIG. 4, a diagram illustrating a horizontal expansion mode is depicted in accordance with a preferred embodiment of the present invention. In this example, node 400 has been expanded in a vertical direction to show nodes 402, 404, and 406. Node 408 has been selected for expansion in a horizontal mode or direction in this illustrative example. As can be seen, node 410 and node 412 are arranged horizontally. Node 414 and node 416 also are shown in a horizontal direction. Thus, in FIG. 4, nodes 402 and 408 are expanded in a horizontal mode or direction.

Turning next to FIGS. 5A and 5B, diagrams illustrating a vertical exclusive mode of expansion are depicted in accordance with a preferred embodiment of the present invention. In this illustrative example in FIG. 5A, node 500 includes nodes 502, 504, and 506, which are child nodes to node 500. Nodes 508, 510, and 512 are an expansion of node 502. As can be seen in this particular example, the child nodes are arranged in a vertical direction, while sibling nodes to the node selected for expansion, such as node 502, are contracted. For example, nodes 504 and 506 are contracted and do not show child nodes. If these nodes had been previously expanded, those expansions would be contracted so that the child nodes are not displayed.

In FIG. 5B, node 504 has been selected for expansion. The selection of this node results in the contraction of all sibling nodes of node 504. In this example, node 502 in FIG. 5A is a sibling node to node 504 and is in an expanded mode. This node contracts as illustrated in FIG. 5B.

Turning now to FIGS. 6A and 6B diagrams illustrating a horizontal exclusive mode of expansion are depicted in accordance with a preferred embodiment of the present invention. In FIG. 6A, node 600 has nodes 602, 604, and 606 as child nodes. These nodes are expanded in a vertical mode with respect to node 600. Node 602 has been selected for expansion in a horizontal exclusive expansion mode, such that nodes 608, 610, and 612 are displayed in a horizontal direction.

In FIG. 6B, node 604 has been selected for expansion in a horizontal exclusive mode. Selection of this node for expansion results in the contraction of any expansions of sibling nodes, such as nodes 602 and 606. In this case, node 602 is contracted such that nodes 608, 610, and 612 are no longer presented in the display of the hierarchical tree. After contraction of sibling nodes, node 604 is expanded to show nodes 614, 616, and 618.

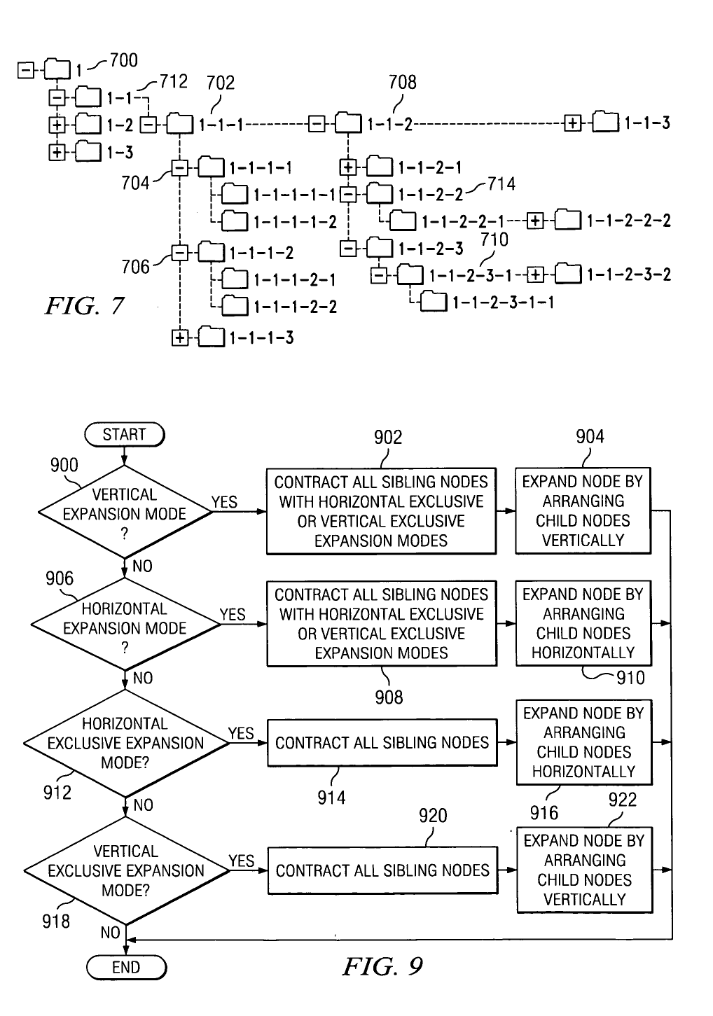

Turning now to FIG. 7, the diagram illustrating combined expansion modes is depicted in accordance with a preferred embodiment of the present invention. In this illustrative example, nodes 700, 702, 704, 706, 708, and 710 are shown in a vertical mode of expansion. Nodes 712 and 714 are shown with a horizontal mode of expansion. Node 700 also contains a vertical exclusive mode of expansion, while node 710 also shows a horizontal exclusive mode of expansion.

With reference to FIG. 8, a control for selecting an expansion mode or direction is depicted in accordance with a preferred embodiment of the present invention. In this illustrative example, control 800 is selected by a user after a node has been selected for expansion. Selection of section 802, 804, 806, and 808 results in different modes of expansion. Section 804 provides for a horizontal expansion. Section 802 results in a horizontal exclusive mode of expansion. Section 806 results in a vertical mode of expansion, while selection of section 808 causes a vertical exclusive mode of expansion.

Control 800 is only an illustration and one way in which expansion modes may be selected. Other types of controls or mechanisms, such as, for example, the use of controls keys, mouse buttons, or combinations of key strokes may be used to select different modes of expansion.

As another example, plus signs and minus signs displayed in the hierarchical trees may be implemented as controls to select a mode of expansion in conjunction with a default, and last used mode. For example, a user may select an expansion mode by activating a pop-up menu for the node that is to be expanded. In response to this activation, the pop-up menu appears and is populated with a menu item for each expansion mode. The user may select an expansion mode by selecting a menu item from the pop-up menu. The different items identify different modes of expansion in this particular example.

The selected node is expanded using the selected expansion mode. Subsequent selections of the expansion control results in an expansion of the node using the last selected expansion mode in these examples. If a user attempts to expand a node by selecting the expansion control without prior selection of an expansion mode, then a default expansion mode is used. The default expansion mode may have been set by the tree control implementation, the application that contains the tree control, or the user through a user settable preference in these examples.

Turning now to FIG. 9, a flowchart illustrating expanding modes is depicted in accordance with a preferred embodiment of the present invention. The process illustrated in FIG. 9 may be implemented in a data processing system, such as data processing system 200 in FIG. 2. This process is initiated after a node has been selected for expansion and a user input has been received to identify the mode of expansion.

The process begins by determining whether a vertical expansion mode has been selected (step 900). If a vertical expansion mode has been selected through the user input, all sibling nodes with horizontal exclusive expansion or vertical exclusive expansion are contracted (step 902). Next, the selected node is expanded by arranging the child nodes vertically (step 904) with the processing terminating thereafter.

With reference back to step 900, if a vertical expansion mode is absent, a determination is made as to whether a horizontal expansion mode is selected (step 906). When the horizontal expansion mode has been selected, all sibling nodes with horizontal exclusive or vertical exclusive expansions are contracted (step 908). Then, the selected node is expanded by arranging the child nodes horizontally (step 910) with the process terminating thereafter.

With reference back to step 906, if a horizontal expansion mode is absent, a determination is made as to whether a horizontal exclusive expansion mode as been selected (step 912). When the horizontal exclusive expansion mode has been selected, all sibling nodes are contracted (step 914). Next, the selected node is expanded by arranging child nodes horizontally (step 916) with the process terminating thereafter.

With reference back to step 912, if a horizontal exclusive expansion mode is absent, a determination is made as to whether a vertical exclusive expansion mode has been selected (step 918). When the vertical exclusive expansion mode has been selected, all sibling nodes are contracted (step 920). Then, the selected node is expanded by arranging child nodes vertically (step 922) with the process terminating thereafter.

With reference again to step 918, if a vertical exclusive expansion mode has not been selected, then the process terminates. In this case, the user input has not selected any of the four illustrative modes of expansion. In this case, the process may terminate without expanding the nodes. Alternatively, a default mode of expansion may be selected for expanding nodes.

Thus, the present invention provides an improved method, apparatus, and computer instructions for displaying nodes in a hierarchical tree. The mechanism of the present invention allows for nodes to be expanded or displayed in different modes or directions. Further, the mechanism of the present invention also allows a user to choose how each hierarchical level in the tree is arranged. Combinations of modes of expansion may be provided. The mechanism also includes an ability to determine how each hierarchical layer should be arranged according to user preferences. The ability to arrange each hierarchical level depending on the type of information the hierarchical level displays is provided by the mechanism of the present invention.

Further, this mechanism provides for increased flexibility in determining how the display area is used in both horizontal and vertical directions. The exclusive modes in these illustrative examples allow a user to treat the nodes of a hierarchical level as a set of categories where the child levels of only one category are displayed at any one time. Having exclusive node processing built into a tree control removing the need for software applications to do exclusive node processing themselves is another advantage provided by the mechanism of the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for controlling a display of hierarchical data, the method comprising:
responsive to a selection of a selected node in a hierarchical tree being displayed on a display in the data processing system, identifying a mode of expansion for the selected node, wherein a plurality of modes of expansion are present for the selected node; and
expanding the selected node in the mode of expansion.

2. The method of claim 1, wherein the identifying step includes:
receiving a user input indicating the mode of expansion.

3. The method of claim 2, wherein the user input is a selection of an area in a plurality of areas in a control.

4. The method of claim 2, wherein the user input is received in a pop-up menu.

5. The method of claim 1, wherein the mode of expansion is identified from one of vertical, horizontal, vertical exclusive, or horizontal exclusive.

6. The method of claim 1, wherein the identifying step includes:
responsive to an absence of a user input selecting the mode of expansion, using a last mode of expansion as the mode of expansion.

7. The method of claim i, wherein the identifying step includes:
responsive to an absence of a user input selecting the mode of expansion, using a default mode of expansion as the mode of expansion.

8. The method of claim 1, wherein the expanding step includes:
responsive to the mode of expansion being vertical, contracting all sibling nodes in a vertical exclusive expansion mode or a horizontal exclusive expansion mode prior to expanding the selected node.

9. The method of claim 1, wherein the expanding step includes:
responsive to the mode of expansion being horizontal, contracting all sibling nodes in a horizontal exclusive expansion mode or a vertical exclusive expansion mode prior to expanding the selected node.

10. The method of claim 1, wherein the expanding step includes:
responsive to the mode of expansion being vertical exclusive, contracting all sibling nodes prior to expanding the selected node.

11. The method of claim 1, wherein the expanding step includes:
responsive to the mode of expansion being horizontal exclusive, contracting all sibling nodes prior to expanding the selected node.

12. A data processing system for controlling a display of hierarchical data, the data processing system comprising:
identifying means, responsive to a selection of a selected node in a hierarchical tree being displayed on a display in the data processing system, for identifying a mode of expansion for the selected node, wherein a plurality of modes of expansion are present for the selected node; and
expanding means for expanding the selected node in the mode of expansion.

13. The data processing system of claim 12, wherein the identifying means includes:
receiving means for receiving a user input indicating the mode of expansion.

14. The data processing system of claim 13, wherein the user input is a selection of an area in a plurality of areas in a control.

15. The data processing system of claim 13, wherein the user input is received in a pop-up menu.

16. The data processing system of claim 12, wherein the mode of expansion is identified from one of vertical, horizontal, vertical exclusive, or horizontal exclusive.

17. The data processing system of claim 12, wherein the identifying means includes:
selecting means, responsive to an absence of a user input, for selecting the mode of expansion, using a last mode of expansion as the mode of expansion.

18. The data processing system of claim 12, wherein the identifying means includes:
selecting means, responsive to an absence of a user input, for selecting the mode of expansion, using a default mode of expansion as the mode of expansion.

19. A computer program product in a computer readable medium for controlling a display of hierarchical data, the computer program product comprising:
first instructions, responsive to a selection of a selected node in a hierarchical tree being displayed in a display in the computer program product, for identifying a mode of expansion for the selected node, wherein a plurality of modes of expansion are present for the selected node; and
second instructions for expanding the selected node in the mode of expansion.

20. The computer program product of claim 19, wherein the first instructions includes:
sub-instructions for receiving a user input indicating the mode of expansion.

21. The computer program product of claim 20, wherein the user input is a selection of an area in a plurality of areas in a control.

22. The computer program product of claim 20, wherein the user input is received in a pop-up menu.

23. The computer program product of claim 19, wherein the mode of expansion is identified from one of vertical, horizontal, vertical exclusive, or horizontal exclusive.

24. The computer program product of claim 19, wherein the first instructions includes:
sub-instructions, responsive to an absence of a user input, for selecting the mode of expansion, using a last mode of expansion as the mode of expansion.

25. The computer program product of claim 19, wherein the first instructions includes:
sub-instructions, responsive to an absence of a user input, for selecting the mode of expansion, using a default mode of expansion as the mode of expansion.

26. The computer program product of claim 19, wherein the second instructions includes:
sub-instructions, responsive to the mode of expansion being vertical, for contracting all sibling nodes in a vertical exclusive expansion mode or a horizontal exclusive expansion mode prior to expanding the selected node.

27. The computer program product of claim 19; wherein the second instructions includes:
sub-instructions, responsive to the mode of expansion being horizontal, for contracting all sibling nodes in a horizontal exclusive expansion mode or a vertical exclusive expansion mode prior to expanding the selected node.

28. The computer program product of claim 19, wherein the second instructions includes:
sub-instructions, responsive to the mode of expansion being vertical exclusive, for contracting all sibling nodes prior to expanding the selected node.

29. The computer program product of claim 19, wherein the second instructions includes:
sub-instructions, responsive to the mode of expansion being horizontal exclusive, for contracting all sibling nodes prior to expanding the selected node.

30. A data processing system comprising:
a bus system;
a memory connected to the bus system, wherein the memory includes a set of instructions; and
a processing unit connected to the bus system, wherein the processing unit executes a set of instructions to identify a mode of expansion for a selected node in response to a selection of the selected node in a hierarchical tree being displayed in a display in the data processing system, wherein a plurality of modes of expansion are present for the selected node; and expand the selected node in the mode of expansion.
